(19) United States
(12) Patent Application Publication
(10) Pub. No.: US 2018/0148376 A1
(43) Pub. Date: May 31, 2018

(54) THERMALLY INSULATING MATERIAL

(71) Applicant: BESIM PTY LTD, Rose Bay (AU)

(72) Inventor: Besim Ben-Nissan, Rose Bay (AU)

(73) Assignee: BESIM PTY LTD, Rose Bay (AU)

(21) Appl. No.: 15/578,337

(22) PCT Filed: May 31, 2016
(86) PCT No.: PCT/AU2016/000187

§ 371 Date: Nov. 30, 2017

(30) Foreign Application Priority Data
May 31, 2015 (AU) 2015902025

(51) Int. Cl. C04B 28/18; C04B 41/50; C04B 35/486; C04B 35/48; C04B 35/447; C04B 35/443; C04B 35/22; C03C 17/22; C04B 35/18; C04B 35/117; C04B 35/053; C04B 33/135; C04B 28/26; C04B 35/20

(52) U.S. Cl. CPC C04B 28/18; C04B 41/5042; C04B 35/486; C04B 35/481; C04B 35/447; C04B 35/443; C04B 35/20; C03C 17/22; C04B 35/18; C04B 35/117; C04B 35/053; C04B 33/1352; C04B 28/26; C04B 35/22

(57) ABSTRACT

Provided are thermally insulating materials comprising 1 to 95 wt % ceramic oxide, 1 to 30 wt % inorganic binding agent, and treated at a temperature of less than about 1000° C.; processes for producing the insulating materials; and uses thereof.

### RELATED APPLICATIONS

This application claims the benefit of Australian Provisional Patent Application No 2015902025 entitled ‘Making nanocoated, light weight insulating materials and structures’ filed on 31 May 2015, the disclosure of which is hereby expressly incorporated by reference in its entirety.

### FIELD

The technology relates to a thermally insulating material and its uses. More particularly, the technology relates to a material comprising a ceramic oxide and an inorganic binding agent, processes for making the material and uses thereof.

### BACKGROUND

Energy conservation is a growing concern worldwide due to the rapid depletion of natural resources and the associated environmental impact. The use of thermal insulation in both residential and commercial buildings is rising in response to these concerns.

Insulting materials are also useful in a variety of other applications where thermal insulation is important, such as cookware, building materials (e.g. bricks and tiles), industrial processes, hazardous waste containment, and protective coatings or cases for electronics. Of particular concern in a number of these applications is the fire resistance of the insulating material due to their potential for exposure to high temperatures.

Typical building insulating materials include fillers for wall or ceiling cavities. Materials such as a cellulose, polystyrene or rock wool are laid or blown in to such cavities and provide thermal insulation at atmospheric temperatures. However, these materials are known to degrade at high temperatures such as those experienced during building fires. In addition, these materials are often costly and onerous to produce and install, and are unsuitable for a wide variety of applications, including structural building materials or protective coatings.

Many other insulating products use materials containing vermiculite, pearlite or silica, however these components pose a number of environmental problems during production and transportation. For example, extensive mining of vermiculite has significantly depleted world supplies, and the limited availability of this natural resource has driven the need for alternative materials. Most current insulating materials use fibre based materials which present a number of handling and health issues. One example is silica glass fibre based materials which, due to the small fibre size, represent a significant risk for inhalation and potential carcinogen effects during production and handling.

Ceramics have traditionally been attractive structural insulating materials (e.g., tiles) due to their strength, hardness and durability. However, traditional ceramics require firing (or sintering) at high temperatures (e.g., >1000° C.) to fuse or bond the material, which can significantly impact on the time, cost and/or difficulty of production. For example, alumina tiles typically require firing at about 1600° C., which imposes significant energy demands and safety concerns. High firing temperatures also render these materials unsuitable for use with combustible materials, such as cardboard or timber. In addition, firing may cause significant dimensional changes to ceramic materials which may be difficult to control for in the raw material.

Accordingly, there is a need for insulating materials which are versatile, inexpensive, efficient to produce and easy to use, while minimising or reducing any negative impact on the environment. The present inventor has developed a thermally insulating material suitable for a number of applications.

### SUMMARY

In a first aspect, there is provided a thermally insulating material comprising:

(a) about 1 to about 95 wt % ceramic oxide;

(b) about 1 to about 30 wt % inorganic binding agent; and

(c) treated at a temperature of less than about 1000° C.

In some embodiments, the thermally insulating material may comprise about 5 to about 90 wt % ceramic oxide. The thermally insulating material may comprise about 10 to about 80 wt % ceramic oxide. The thermally insulating material may comprise about 10 to about 95 wt %, or about 10 to about 85 wt %, or about 5 to about 80 wt %, or about 20 to about 85 wt %, or about 20 to about 90 wt %, or about 1 to about 75 wt %, or about 15 to about 85 wt % ceramic oxide.

In some embodiments, the ceramic oxide may have a mean particle size of less than about 350 μm. The mean particle size may be from about 30 to about 300 μm. The mean particle size may be from about 1 to about 350 μm, or about 10 to about 350 μm, or about 10 to about 300 μm, or about 10 to about 250 μm, or about 50 to about 300 μm. The mean particle size may be about 1, 10, 20, 30, 50, 60, 70, 80, 90, 100, 150, 200, 250, 300 or 350 μm. In some embodiments, the ceramic oxide may have a mean particle size of less than about 1000 nm. The mean particle size may be from about 1 to about 1000 nm, or about 1 to about 500 nm, or about 10 to about 300 nm, about 10 to about 200 nm, about 30 to about 300 nm, about 10 to about 150 nm, or about 50 to about 300 nm.

In some embodiments, the ceramic oxide may be an oxide of aluminium, barium, beryllium, calcium, chromium, cobalt, copper, iron, lithium, magnesium, manganese, phosphorous, silicon, strontium, tantalum, tin, titanium, tungsten, yttrium, zinc, zirconium, or combinations thereof. The ceramic oxide may be selected from sodium oxide, magnesium oxide, potassium oxide, calcium oxide, alumina, silica, sodium silicate, magnesium silicate, potassium silicate, calcium silicate, aluminium silicate, zirconium silicate, sodium aluminate, magnesium aluminate, calcium aluminate, zirconium aluminate, nickel aluminate, sodium phosphate, magnesium phosphate, calcium phosphate, aluminium phosphate, ferrous oxide, ferric oxide, zirconium oxide, magnesium zirconate, calcium zirconate, or combinations thereof.

In some embodiments, the ceramic oxide may be treated up to about 1000° C. prior to use in the insulating material. The ceramic oxide may be treated by heating to about 1000° C., or about 900° C., or about 800° C., or about 700° C., or about 600° C., or about 500° C., or about 400° C., or about 300° C., or about 200° C. or about 100° C. prior to use in the insulating material.

In some embodiments, the insulating material may comprise about 5 to about 30 wt % inorganic binding agent. The insulating material may comprise about 5 to about 25 wt % inorganic binding agent. The insulating material may comprise about 1 to about 30 wt %, or about 1 to about 25 wt %, or about 10 to about 30 wt %, or about 5 to about 25 wt % or about 5 to about 20 wt % inorganic binding agent.

In some embodiments, the inorganic binding agent may have a mean particle size of less than about 350 μm. The mean particle size may be from about 30 to about 300 μm. The mean particle size may be from about 1 to about 350 μm, or about 10 to about 350 μm, or about 10 to about 300 μm, or about 30 to about 300 μm, or about 10 to about 250 μm, or about 50 to about 300 μm.

In some embodiments, the inorganic binding agent may be a phosphate or silicate binding agent. The inorganic binding agent may be selected from calcium orthophosphate, aluminium orthophosphate, sodium silicate, potassium silicate, calcium silicate, or combinations thereof.

In some embodiments, the inorganic binding agent may be treated prior to use in the insulating material. The inorganic binding agent may be heated to about 1000° C., or about 900° C., or about 800° C., or about 700° C., or about 600° C., or about 500° C., or about 400° C., or about 300° C., or about 200° C. or about 100° C. prior to use in the insulating material.

In some embodiments, treating may comprise drying, calcining, sintering and/or firing of the insulating material. Treating may comprise heating up to about 1000° C. Treating may comprise heating to about 900° C., or about 800° C., or about 700° C., or about 600° C., or about 500° C., or about 400° C., or about 300° C. or about 200° C., or about 150° C., or about 100° C., or about 50° C., or about 30° C., or about 25° C. or about 20° C.

In some embodiments, the insulting material may further comprise fly ash. The insulting material may comprise about 10 to about 80 wt % fly ash. The insulting material may comprise from about 10 to about 70 wt %, or about 20 to about 80 wt %, or about 20 to about 70 wt % fly ash. The fly ash may be obtained from a coal burning power station. In some embodiments, the fly ash may be treated prior to use in the insulating material. The fly ash may be treated by heating to about 1000° C., or about 900° C., or about 800° C., or about 700° C., or about 600° C., or about 500° C., or about 400° C., or about 300° C., or about 200° C. or about 100° C.

In some embodiments, the insulting material may further comprise clay. The insulting material may comprise about 10 to about 80 wt % clay. The insulting material may comprise from about 10 to about 70 wt %, or about 20 to about 80 wt %, or about 20 to about 70 wt %, or about 15 to about 85 wt % clay.

In some embodiments, the clay may be a kaolinite, hallyosite, illite, smectite, muscovite, bentonite, and attapulgite, or any combination thereof. The clay may be a commercially available kaolinite clay, ball clay, china clay, stoneware, terracotta or fire clay. In some embodiments, the clay may be treated prior to use in the insulating material. The clay may be treated by heating to about 1000° C., or about 900° C., or about 800° C., or about 700° C., or about 600° C., or about 500° C., or about 400° C., or about 300° C., or about 200° C. or about 100° C. prior to use in the insulating material.

In some embodiments, the insulting material may further comprise an additive. The additive may be selected from a colourant, fibres, dispersant, surfactant, sintering aid, stearate lubricant, non-oxide ceramic or any combination thereof.

In some embodiments, the insulting material may be in the form of a building material, brick, tile, panel, rod, cylinder, block, board, plate, laminate, foam, paint, paste, slurry or dispersion, or combinations thereof. In some embodiments, the insulting material may further comprise a ceramic oxide nanocoating. The ceramic oxide nanocoating may have an average thickness of less than about 500 nm. The ceramic oxide nanocoating may have an average thickness of less than about 450 nm, or about 400 nm, or about 350 nm, or about 300 nm, or about 250 nm, or about 200 nm, or about 150 nm, or about 100 nm, or about 50 nm. The ceramic oxide nanocoating may comprise silica, alumina, aluminium silicate, calcium phosphate, aluminium phosphate, zirconia, partially stabilised zirconia, or combinations thereof.

In some embodiments, the ceramic oxide nanocoating may comprise a mean particle size of less than about 300 nm. The mean particle size may be about 10 to about 300 nm, or about 10 to about 200 nm, or about 30 to about 300 nm, or about 10 to about 150 nm, or about 50 to about 300 nm.

The thermally insulating material can be treated by heating at about 1000° C., or about 900° C., or about 800° C., or about 700° C., or about 600° C., or about 500° C., or about 400° C., or about 300° C. or about 200° C., or about 150° C., or about 100° C., or about 50° C., or about 30° C., or about 25° C. or about 20° C.

Treating by heating can remove unwanted water from the insulating material or assist in curing the insulating material when formed as an insulating product.

In an embodiment, the insulting material comprises:
(a) 20-80 wt % fly ash;
(b) 10-80 wt % clay;
(c) 1-40 wt % ceramic oxide;
(d) 5-30 wt % inorganic binding agent; and
(e) treated at a temperature of less than about 1000° C.

In an embodiment, the insulting material comprises:
(a) 75 wt % ceramic oxide;
(b) 25 wt % inorganic binding agent; and
(c) treated at a temperature from 20° C. to 1000° C.

In an embodiment, the insulting material comprises:
(a) 18 wt % fly ash;
(b) 36 wt % clay;
(c) 18 wt % ceramic oxide;
(d) 28 wt % inorganic binding agent; and
(e) treated at a temperature from 20° C. to 1000° C.

In an embodiment, the insulting material comprises:
(a) 30 wt % clay;
(b) 40 wt % ceramic oxide;
(c) 30 wt % inorganic binding agent; and
(d) treated at a temperature from 20° C. to 1000° C.

In an embodiment, the insulting material comprises:
(a) 50 wt % fly ash;
(b) 15 wt % clay;
(c) 5 wt % ceramic oxide;
(d) 30 wt % inorganic binder, and
(e) treated at a temperature from 20° C. to 1000° C.

In a second aspect, there is provided a process for producing a thermally insulating product comprising:
(a) mixing about 1 to about 95 wt % ceramic oxide, about 1 to about 30 wt % inorganic binding agent and water to form a slurry;
(b) forming the slurry into a shaped body; and
(c) treating the shaped body at a temperature of less than about 1000° C. to produce the thermally insulating product.

In some embodiments, step (a) may comprise mixing about 5 to about 90 wt % ceramic oxide. Step (a) may comprise mixing about 10 to about 80 wt % ceramic oxide. Step (a) may comprise mixing about 10 to about 95 wt %, or about 10 to about 85 wt %, or about 5 to about 80%, or about 20 to about 85 wt %, or about 20 to about 90 wt %, or about 1 to about 75 wt %, or about 15 to about 85 wt % ceramic oxide.

In some embodiments, the ceramic oxide may have a mean particle size of less than about 350 μm. The mean particle size may be from about 30 to about 300 μm. The mean particle size may be from about 1 to about 350 μm, or about 10 to about 350 μm, or about 10 to about 300 μm, or about 10 to about 250 μm, or about 50 to about 300 μm.

In some embodiments, the ceramic oxide may have a mean particle size of less than about 1000 nm. The mean particle size may be from about 1 to about 1000 nm, or about 1 to about 500 nm, or about 10 to about 300 nm, about 10 to about 200 nm, about 30 to about 300 nm, about 10 to about 150 nm, or about 50 to about 300 nm.

In some embodiments, the ceramic oxide may be an oxide of aluminium, barium, beryllium, calcium, chromium, cobalt, copper, iron, lithium, magnesium, manganese, phosphorous, silicon, strontium, tantalum, tin, titanium, tungsten, yttrium, zinc, zirconium, or combinations thereof. In some embodiments, the ceramic oxide may be selected from sodium oxide, magnesium oxide, potassium oxide, calcium oxide, alumina, silica, sodium silicate, magnesium silicate, potassium silicate, calcium silicate, aluminium silicate, zirconium silicate, sodium aluminate, magnesium aluminate, calcium aluminate, zirconium aluminate, nickel aluminate, sodium phosphate, magnesium phosphate, calcium phosphate, aluminium phosphate, ferrous oxide, ferric oxide, zirconium oxide, magnesium zirconate, calcium zirconate, or combinations thereof.

In some embodiments, step (a) may comprise mixing about 5 to about 30 wt % inorganic binding agent. Step (a) may comprise mixing about 5 to about 25 wt % inorganic binding agent. Step (a) may comprise mixing about 1 to about 30 wt %, or about 1 to about 25 wt %, or about 10 to about 30 wt %, or about 5 to about 25 wt % or about 5 to about 20 wt % inorganic binding agent.

In some embodiments, the inorganic binding agent may have a mean particle size of less than about 350 μm. The mean particle size may be from about 30 to about 300 μm. The mean particle size may be from about 1 to about 350 μm, or about 10 to about 350 μm, or about 10 to about 300 μm, or about 30 to about 300 μm, or about 10 to about 250 μm, or about 50 to about 300 μm.

In some embodiments, the inorganic binding agent may be a phosphate or silicate binding agent. The inorganic binding agent may be selected from the group consisting of calcium orthophosphate, aluminium orthophosphate, sodium silicate, potassium silicate, calcium silicate, and combinations thereof.

In some embodiments, step (a) may comprise mixing fly ash. Step (a) may comprise mixing about 10 to about 80 wt % fly ash. Step (a) may comprise mixing from about 10 to about 70 wt %, or about 20 to about 80 wt %, or about 20 to about 70 wt % fly ash. The fly ash may be obtained from coal burning power station. In some embodiments, the fly ash may be treated prior to step (a). The fly ash may be treated by heating to about 1000° C., or about 900° C., or about 800° C., or about 700° C., or about 600° C., or about 500° C., or about 400° C., or about 300° C., or about 200° C. or about 100° C. prior to step (a).

In some embodiments, step (a) may comprise mixing clay. Step (a) may comprise mixing about 10 to about 80 wt % clay. Step (a) may comprise mixing from about 10 to about 70 wt %, or about 20 to about 80 wt %, or about 20 to about 70 wt %, or about 15 to about 85 wt % clay.

In some embodiments, the clay may be a kaolinite, hallyosite, illite, smectite, muscovite, bentonite, and attapulgite, or any combination thereof. The clay may be a commercially available kaolinite clay, ball clay, china clay, stoneware, terracotta or fire clay. In some embodiments, the clay may be treated prior to step (a). The clay may be treated by heating to about 1000° C., or about 900° C., or about 800° C., or about 700° C., or about 600° C., or about 500° C., or about 400° C., or about 300° C., or about 200° C. or about 100° C. prior to step (a).

In some embodiments, step (a) may further comprise mixing an additive. The additive may be selected from the group consisting of a colourant, fibres, dispersant, surfactant, sintering aid, stearate lubricant, or any combination thereof.

The formation of a slurry allows the viscosity of the material to be controlled prior to formation of the insulating product. In some embodiments, the amount of water added to form a slurry may be from 10 to about 500 wt % with respect to the total solid content. For example, the amount of water added to form a slurry may be from 10 to about 500 wt %, or about 10 to about 300 wt %, or about 50 to about 500 wt %, or about 100 to about 400 wt %, or about 20 to about 250 wt %, or about 100 to about 300 wt %, e.g. about 10, 20, 50, 100, 150, 200, 250, 300, 350, 400, 450 or 500 wt % with respect to the total solid content.

In some embodiments, step (b) may comprise casting, pouring, spraying, injecting, moulding, extruding, ramming or pressing.

In some embodiments, step (c) comprises heating at about 1000° C., or about 900° C., or about 800° C., or about 700° C., or about 600° C., or about 500° C., or about 400° C., or about 300° C. or about 200° C., or about 150° C., or about 100° C., or about 50° C., or about 30° C., or about 25° C. or about 20° C. Step (c) may comprise drying at room temperature.

The treating step (c) can remove unwanted water from the product or assist in curing the insulating material to form the product.

In some embodiments, thermally insulating product may comprise a building material, brick, tile, panel, rod, cylinder, block, board, plate, laminate, foam, paint, paste, slurry or dispersion, or combinations thereof.

In some embodiments, the process may further comprise coating the shaped body with a ceramic oxide nanocoating. The ceramic oxide nanocoating may have an average thickness of less than about 500 nm. The ceramic oxide nanocoating may have an average thickness of less than about 450 nm, or about 400 nm, or about 350 nm, or about 300 nm, or about 250 nm, or about 200 nm, or about 150 nm, or about 100 nm, or about 50 nm. The ceramic oxide nanocoating may comprise silica, alumina, aluminium silicate, calcium phosphate, aluminium phosphate, zirconia, partially stabilised zirconia, or combinations thereof.

In some embodiments, the ceramic oxide nanocoating may comprise a mean particle size of less than about 300 nm. The mean particle size may be from about 10 to about 300 nm, or about 10 to about 200 nm, or about 30 to about 300 nm, or about 10 to about 150 nm, or about 50 to about 300 nm.

In some embodiments, the nanocoating may be applied by spraying a sol-gel derived solution of the nanocoating onto the shaped body.

In a third aspect, there is provided a thermally insulating product produced by the process of the second aspect.

In a fourth aspect, there is provided a method for improving the heat resistance of an article comprising at least partially coating the article with the thermally insulating material according to the first aspect.

In some embodiments, the article may comprise metal, ceramic, glass, timber, polymers, clay, concrete, polystyrene, brick, plaster, Gyprock™, natural or synthetic stone, natural or synthetic fibres, cardboard, laminate, composite material, or combinations thereof.

Any discussion of documents, acts, materials, devices, articles or the like which has been included in the present specification is solely for the purpose of providing a context for the present invention. It is not to be taken as an admission that any or all of these matters form part of the prior art base or were common general knowledge in the field relevant to the present invention as it existed before the priority date of each claim of this specification.

### DESCRIPTION OF THE DRAWINGS

The technology will now be further explained and illustrated by reference to the accompanying drawings in which:

FIG. 1 shows the average dimensional change, expressed as % mass reduction, of a thermally insulating material according to the present technology versus a vermiculite containing product after firing at 1000° C., 1100° C., 1200° C. and 1300° C.

FIG. 2 is a temperature vs time plot of a solid insulating block material of the present technology (BBN 1209) and an industrial insulating solid vermiculate material (INS 1209) when heated to at 1000° C.

FIG. 3 illustrates a typically furnace cycle for a material treated to 1300° C. for 1 hour.

### DEFINITIONS

The indefinite articles ‘a’ and ‘an’ mean ‘at least one’ or ‘one or more’ when used in this application, including the claims, unless specifically indicated otherwise.

As used herein, the term ‘about’ means±10% of the recited value.

As used herein, the term ‘ceramic oxide’ means any non-organic oxide or salt thereof.

As used herein, the term ‘dimensional stability’ when used with reference to a particular material refers to the ability of that material to retain its overall dimensions (including volume and mass) when treated under specified conditions compared to the untreated material.

As used herein, the term ‘dimensional change’ when used with reference to a particular material refers to the change in overall dimensions (including volume and mass) of the material when treated under specified conditions compared to the untreated material, expressed as a percentage (%) change.

As used herein, the term ‘heat resistant’ when used in relation to a material means that the dimensional change of the material is less than about 12% when heated to about 800° C. to about 1350° C.

As used herein, the term ‘water resistant’ when used in relation to a material means that the dimensional change of the material is less than about 10% when treated with water for at least one year.

As used herein, the term ‘SiAlONs’ refers to ceramic materials based on the elements silicon (Si), aluminium (Al), oxygen (O) and nitrogen (N).

Unless otherwise specified, any reference to a percentage by weight (wt %) of a component of a material or composition described herein refers to the wt % of the specified component with respect to the total solid components of the material or composition and, for example, does not include any water that may be present.

Throughout this specification the terms ‘binding agent’ and ‘binder’ are equivalent.

Throughout this specification the terms ‘thermally insulating material’ and ‘insulating material’ are equivalent when referring to the current technology.

It is to be noted that, throughout the description and claims of this specification, the word ‘comprise’ and variations of the word, such as ‘comprising’ and ‘comprises’, is not intended to exclude other variants or additional components, integers or steps. Modifications and improvements to the technology will be readily apparent to those skilled in the art. Such modifications and improvements are intended to be within the scope of this technology.

### DESCRIPTION OF EMBODIMENTS

The present technology relates to thermally insulating materials comprising a ceramic oxide and a binding agent and processes for producing the materials. The insulating materials provided herein can be inexpensive and efficient to produce, and offer a versatile material for use in a wide variety of applications.

The thermally insulating materials disclosed herein comprises a ceramic oxide. The ceramic oxide may be any non-organic oxide or salt thereof. The ceramic oxide may be a single ceramic oxide, or a combination of ceramic oxides. For example, the ceramic oxide may be an oxide of aluminium, barium, beryllium, calcium, chromium, cobalt, copper, iron, lithium, magnesium, manganese, phosphorous, silicon, strontium, tantalum, tin, titanium, tungsten, yttrium, zinc, zirconium, or any combination thereof. In various embodiments the ceramic oxide may be sodium oxide, magnesium oxide, potassium oxide, calcium oxide, alumina, silica, sodium silicate, magnesium silicate, potassium silicate, calcium silicate, aluminium silicate, zirconium silicate, sodium aluminate, magnesium aluminate, calcium aluminate, zirconium aluminate, nickel aluminate, sodium phosphate, magnesium phosphate, calcium phosphate, aluminium phosphate, ferrous oxide, ferric oxide, zirconium oxide, magnesium zirconate, calcium zirconate, or combinations thereof.

The thermally insulating material may comprise the ceramic oxide in any suitable amount. A person skilled in the art will appreciate that the amount of ceramic oxide will depend on the intended use of the insulating material and the particular ceramic oxide or combination thereof. In various embodiments, the insulating material may comprise the ceramic oxide in an amount from about 1 to about 95 wt %. For example, the thermally insulating material may comprise a ceramic oxide in an amount from about 1 to about 95 wt %, about 5 to about 90 wt %, or about 10 to about 80 wt %, about 10 to about 95 wt %, or about 10 to about 85 wt %, or about 5 to about 80 wt %, or about 20 to about 85 wt %, or about 20 to about 90 wt %, or about 1 to about 75 wt %, or about 15 to about 85 wt %, e.g., about 1, 5, 10, 15, 20, 25, 30, 25, 40, 45, 50, 55, 60, 65, 70, 75, 80, 85, 90 or 95 wt %.

The amount of ceramic oxide in the insulating material may vary depending on the source of the ceramic oxide. Ceramic oxide(s) may be obtained from any suitable source. For example, the ceramic oxide may be a substantially pure ceramic oxide or combination thereof, or it may be provided in the form of a ceramic oxide containing material. Non-limiting examples of ceramic oxide containing materials include bauxite, rutile or zircon ores. In some embodiments, the ceramic oxide containing material may consist essentially of a ceramic oxide or combination thereof. In various embodiments, the ceramic oxide containing material may comprise the ceramic oxide in an amount from about 10 to about 100 wt %. For example, the ceramic oxide containing material may comprise a ceramic oxide in an amount from about 10 to about 100 wt %, or about 10 to about 90 wt %, or about 20 to about 90 wt %, or about 10 to about 80 wt %, or about 30 to about 90 wt %, or about 25 to about 75%, e.g., about 10, 15, 20, 25, 30, 25, 40, 45, 50, 55, 60, 65, 70, 75, 80, 90 or 100 wt %. The amount of ceramic oxide present in the ceramic oxide containing material may be determined by any suitable method known in the art, for example, x-ray powder diffraction (XRD).

The particle size of the ceramic oxide may affect the mechanical properties (strength) and/or insulating properties of the insulating material. Typically, the smaller the particle size, the smaller the flaws at the grain boundaries of the material, making the material less susceptible fracturing at the grain boundaries. The skilled person will appreciate that that the optimum particle size will depend on the particular ceramic oxide. In addition, particle size uniformity may provide a more closely packed crystalline array of particles, and thereby improve the density and insulating properties and/or strength of the material. A smaller particle size may also reduce the temperature required for sintering, and consequent densification, to occur.

Accordingly, in some embodiments the ceramic oxide may comprise ceramic oxide particles of less than about 350 μm. The mean particle size of the ceramic oxide may be less than about 350 μm. For example, the particle size may be from about 30 to about 300 μm, about 1 to about 350 μm, or about 1 to about 350 μm, or about 10 to about 350 μm, or about 10 to about 300 μm, or about 10 to about 250 μm, or about 50 to about 300 μm, e.g., about 1, 10, 20, 30, 50, 60, 70, 80, 90, 100, 150, 200, 250, 300 or 350 μm. In some embodiments, the ceramic oxide may comprise superfine ceramic oxide particles of less than 1000 nm (1 μm). The mean particle size of the ceramic oxide may be less than about 1000 nm. For example, the superfine particle size may be from about 1 to about 1000 nm, or about 1 to about 500 nm, or about 10 to about 300 nm, about 10 to about 200 nm, about 30 to about 300 nm, about 10 to about 150 nm, or about 50 to about 300 nm.

In some embodiments the ceramic oxide comprises hollow (porous) microspheres. The presence of hollow microspheres may reduce the overall weight and/or density of the thermally insulating material and improve insulating properties. In some embodiments, the hollow microspheres may have a mean spherical diameter from about 1 to about 350 μm, about 1 to about 350 μm, about 10 to about 350 μm, about 10 to about 300 μm, about 30 to about 300 μm, about 10 to about 250 μm, or about 50 to about 300 μm, e.g., about 1, 10, 20, 30, 50, 60, 70, 80, 90, 100, 150, 200, 250, 300 or 350 μm.

The ceramic oxide (or ceramic oxide containing material) may be treated prior to use in the insulating material. For example, the ceramic oxide may be treated by drying or calcining the material. In some embodiments, the ceramic oxide may be treated up to about 1000° C. prior to use in the insulating material. For example, the ceramic oxide may be treated by heating to about 1000° C., or about 900° C., or about 800° C., or about 700° C., or about 600° C., or about 500° C., or about 400° C., or about 300° C., or about 200° C. or about 100° C. The skilled person will appreciate that the duration and temperature of heating will depend on the intended outcome of the heating process. For example, drying may be achieved by heating the ceramic oxide or ceramic oxide containing material to about 110° C. for 1 hour. In another example, calcining may be achieved by heating a ceramic oxide to about 800° C. for 2 hours. An appropriate temperature and duration will be readily determined by a person skilled in the art.

In some embodiments, the thermally insulating material may comprise fly ash, a waste product from coal fired power stations burning brown coals. The brown coal is typically prepared as a pulverized fine powder in which form it is delivered to vertical water wall boilers where it is combusted to release heat for steam generation by turbines. The majority of the combustion products are fine particles which are carried by the flue gases out of the boiler and are known as fly ash. Fly ash comprises about 80% of the total ash content of the combusted coal. Fly ash typically contains about 5-20% char (unburnt or partially carbonised coal). The coarser ash particles, principally sand, settle to the bottom of the boiler from where they are collected. This fraction is known as bottom ash and generally constitutes about 20% of the total ash content of the combusted coal.

The process of burning coal in thermal power plants produces fly ash containing hollow microspheres known as cenospheres. Cenospheres are low-density (about 0.4 to 0.8 g/cm³) hollow microspheres produced during coal burning at temperatures of about 1500 to about 1750° C. The precise composition of fly ash and, consequently, the cenospheres may vary significantly depending on the composition of the coal being burned, which in turn may depend on the source of the coal. However, cenospheres typically comprise hollow microspheres of silica, alumina and/or aluminosilicates. Other ceramic oxides commonly found in fly ash include calcium oxide and ferric oxide. The composition, purity and the structure of fly ash may be determined by any suitable method known in the art, for example, x-ray powder diffraction (XRD) or Inductive Plasma Spectroscopy (ICP).

Fly ash is considered hazardous waste due to the presence of non-trivial amounts (up to hundreds of parts per million) of toxic components, including heavy metals such as hexavalent chromium, mercury and lead, and other hazardous chemicals which can have detrimental effects on public health and the environment. Accordingly, the flue gases from the boiler are often treated with an electrostatic precipitator or other particle filtration system to remove the fine particles (>99%). Disposal of fly ash collected by coal burning power stations is heavily regulated in many countries and, as a result, may be onerous and/or expensive. Fly ash is therefore a readily available and inexpensive, and repurposing of this waste material is also desirable to reduce the health and environmental impact of coal combustion. In addition, the low density of fly ash renders fly ash may render this material advantageous for producing lightweight insulating materials.

Accordingly, in various embodiments, the thermally insulating material may comprise fly ash. The fly ash may be obtained from any suitable source, but is typically purchased as a waste product from coal burning power stations. Advantageously, the use of fly ash in the present technology may reduce the environmental impact of coal combustion. Additionally or alternatively, the inclusion of fly ash in the insulating material of the present technology may reduce the overall weight and/or density of the insulating material. Fly ash may contain ceramic oxides in varying amounts depending on the source.

In various embodiments, the thermally insulating material may comprise fly ash in an amount from about 10 to about 80 wt %. For example, the thermally insulating materials may comprise fly ash in an amount from about 10 to about 80 wt %, or about 10 to about 70 wt %, or about 20 to about 80 wt %, or about 20 to about 70 wt %, or about 15 to about 85 wt %, e.g., about 10, 15, 20, 25, 30, 25, 40, 45, 50, 55, 60, 65, 70, 75, or 80 wt %. The skilled person will appreciate that the amount of fly ash will depend on the intended use of the insulating material, and that fly ash may be used in combination with other additives to achieve the desired properties.

The fly ash may be used in the insulating materials as a raw (unprocessed) material, or it may be treated or processed. Processing of raw fly ash may involve calcining, firing, filtering or grinding to remove contaminants, reduce the particle size and/or obtain a particular composition. For example, fly ash may be heated prior to use in the insulating material to dry the fly ash and/or remove any organic contaminants such unburned coal or organic materials from the coal combustion process.

In some embodiments, the fly ash may be treated by heated up to about 1000° C. prior to use in the insulating material. For example, the fly ash may be heated to about 1000° C., or about 900° C., or about 800° C., or about 700° C., or about 600° C., or about 500° C., or about 400° C., or about 300° C., or about 200° C. or about 100° C. It will be appreciated by a person skilled in the art that the temperature and duration of heating may depend on the intended outcome of the heating process and/or the precise composition of the raw fly ash.

In some embodiments, the insulting materials of the present technology may comprise clay. The main component of clays are hydrous aluminium phyllosilicates, with varying amounts of other minerals such as iron, magnesium and alkaline earth metals. The clay may have any suitable composition. In some embodiments, the clay may be a combination of clays. For example, the clay may be a kaolinite, hallyosite, illite, smectite, muscovite, bentonite, and attapulgite, or any combination thereof. In some embodiments, the clay may be a commercially available kaolinite clay, ball clay, china clay, stoneware, terracotta or fire clay. In other embodiments, the clay may be a smectite or bentonite clay, such as sodium bentonite or montmorillonite. Clays suitable for use in the present technology may be commercially available for ceramic/pottery production, such as ball clay, china clay, fire clay or kaolinite, or mixtures thereof. A typical ball clay may comprise approximately the following composition: silica (SiO₂) 65 wt %; alumina (Al₂O₃) 20 wt %; ferric oxide (Fe₂O₃) 2 wt %; ferrous oxide (FeO) 0.5 wt %, magnesium oxide (MgO) 2.5 wt %, calcium oxide (CaO); 0.5 wt %, sodium oxide (Na₂O) 2 wt %; and potassium oxide (K₂O) 0.5 wt % and other impurities.

Clays may contain a significant amount of water (up to about 12-35 wt %), which causes the clay to swell. The water content of clay may depend on the source of the clay, for example, water may be added to commercially available ceramic clays to improve plasticity and facilitate pressing or extrusion. The clay may be heated prior to use in the insulating material to, for example, dry or calcine the clay. This may increase the dimensional stability of the clay and prevent swelling during use. Heating the clay, particularly to higher temperatures during calcining (e.g., up to about 1000° C.), may also affect its porosity, thereby altering its strength characteristics. For example, lower temperatures generally produce a more porous clay with lower density which may have greater insulating properties than their less porous counterparts, while higher temperatures reduce the porosity, giving a stronger, denser material which may be more resistant to crushing during manufacturing and installation than their more porous counterparts. In other embodiments, the clay may be used without drying or it may be partially dried. Wet clay may contribute to the binding of the insulating material. For example, montmorillonite clay becomes a strongly bonded plastic material when mixed with water. However, high temperature firing (>1000° C.) is typically required to achieve adequate binding strength in the final insulating material from clay alone.

Accordingly, in some embodiments, the clay may be heated up to about 1000° C. prior to use in the insulating material. For example, the clay may be heated up to about 1000° C., or about 900° C., or about 800° C., or about 700° C., or about 600° C., or about 500° C., or about 400° C., or about 300° C., or about 200° C. or about 100° C. The skilled person will appreciate that the temperature and duration of heating may depend on the type of clay, the intended outcome of the heating process, and an appropriate temperature and duration will be readily determined by a person skilled in the art.

The thermally insulating material may comprise clay in any suitable amount. A person skilled in the art will appreciate the amount of clay will depend on the intended use of the insulating material, the precise composition of the clay and, in some cases, the required density of the insulating material. In various embodiments, the thermally insulating material comprises clay in an about from about 10 to about 80 wt %. For example, the thermally insulating materials may comprise clay in an amount from about 10 to about 80 wt %, or about 10 to about 70 wt %, or about 20 to about 80 wt %, or about 20 to about 70 wt %, or about 15 to about 85 wt %, e.g., about 10, 15, 20, 25, 30, 25, 40, 45, 50, 55, 60, 65, 70, 75, or 80 wt %.

Clays, particularly commercially available clays, typically have a small particle size, i.e., about 0.1 to about 350 μm, which may provide improved insulating properties and/or strength of the insulating material compared to larger particle sizes. In various embodiments the clay, including any component ceramic oxides, may comprise particles of less than about 350 μm. In some embodiments, the mean particle size of the clay may be less than about 350 μm. For example, the particle size may be from about 0.1 to about 350 μm, or about 0.1 to about 300 μm, or about 0.1 to about 200 μm, or about 10 to about 300 μm, or about 30 to about 300 μm, or about 1 to about 250 μm, or about 1 to about 300 μm, e.g., about 0.1, 0.5, 1, 10, 20, 30, 50, 60, 70, 80, 90, 100, 150, 200, 250, 300 or 350 μm.

In some embodiments, additional components of the insulating material, e.g., fly ash or clay, may also contain varying amounts of ceramic oxide(s). It is to be understood that, for the purposes of the present technology, any ceramic oxide(s) of the additional components included in the insulating material would be additional to the ceramic oxide added to the insulating material.

The insulating materials described herein also comprise a binding agent (or binder). Use of a binding agent may allow for the chemical binding of all, or substantially all, of the components of the insulating material. Advantageously, binding of the components may prevent potentially hazardous components being released from the insulating material, e.g., silica. The binding agent may be an organic or inorganic binding agent. However, inorganic binding agents are advantageous for high temperature insulation applications as organic binders tend to disintegrate at around temperatures around 200° C. to 500° C., and may be converted to carbon dioxide or carbon monoxide at temperatures around 1100° C. The inventor has postulated that the addition of a binder (e.g., an inorganic binders) can generate a strongly bonded interface between the ceramic oxide particles that can resist degradation.

The binding strength may be improved by heating the insulating material comprising a binder above room temperature. For example, in the case of a silicate binder, the greater the temperature the more water is removed from the binder providing a glassy film of liquid silicate. Heating the material may also improve the water resistance of the material compared to the same material when dried at room temperature, as the glassy silicate film has less affinity for water once dried.

In some embodiments, the bonding strength and/or water resistance of the insulating material may be increased by heating (firing) the material to a temperature between about 60° C. and about 1000° C. For example, the temperature may be increased to about 60° C., or about 80° C., or about 100° C., or about 120° C., or about 140° C., or about 160° C., or about 180° C., or about 200° C., or about 250° C., or about 300° C., or about 350° C., or about 400° C., or about 450° C., or about 500° C., or about 600° C., or about 700° C., or about 800° C., or about 900° C., or about 1000° C.

Suitable inorganic binding agents may be any inorganic material which, when added to a material improve the bonding strength of the material. A binder may be a solid or liquid which forms a bridge, film or matrix filler or that causes a chemical reaction (William H. Engelleitner, “Glossary of agglomeration terms” (February, 1990) Powder and Bulk Engineering, 44-48). In various embodiments, the binding agent may be a phosphate such as calcium orthophosphate or aluminium orthophosphate, or a silicate such as sodium silicate, potassium silicate or calcium silicate, or any combination thereof.

The insulating material may comprise the binding agent in any suitable amount to achieve binding of the material. In various embodiments, the insulating material comprises the binding agent in an amount from about 1 to about 30 wt %. For example, the insulating material may comprise the binding agent in an amount from about 5 to about 30 wt %, or about 5 to about 25 wt %, or about 1 to about 30 wt %, or about 1 to about 25 wt %, or about 10 to about 30 wt %, or about 5 to about 25 wt % or about 5 to about 20 wt %, e.g., about 1, 5, 10, 15, 20, 25 or 30 wt %.

The binding agent may be in the form of a solid (e.g., a powder), an aqueous slurry or any other suitable form. In certain embodiments, the binding agent may be dried and/or calcined prior to use in the insulating material. For example, the binding agent may be treated up to about 1000° C., or about 900° C., or about 800° C., or about 700° C., or about 600° C., or about 500° C., or about 400° C., or about 300° C., or about 200° C. or about 100° C.

The binding agent may have a particle size consistent with that of the ceramic oxide particles so as to maintain the strength and insulating characteristics of the resultant material. In some embodiments, the binding agents may have a particle size of less than about 350 μm. For example, the particle size may be from about 1 to about 350 μm, or about 1 to about 350 μm, or about 10 to about 350 μm, or about 10 to about 300 μm, or about 30 to about 300 μm, or about 10 to about 250 μm, or about 50 to about 300 μm, e.g., about 1, 10, 20, 30, 50, 60, 70, 80, 90, 100, 150, 200, 250, 300 or 350 μm.

The insulating materials described may additionally comprise any suitable additives. For example, the insulating material may comprise a colourant, fibres, dispersant, surfactant, sintering aid, stearate lubricant, non-oxide ceramic or any combination thereof. For example, in some embodiments, the additive may be a non-oxide ceramic such as tungsten carbide, titanium carbide, titanium nitride, zirconium nitride, titanium oxynitride, silicon oxynitride, zirconium oxynitride, aluminium nitride, SiAlON, or combinations thereof.

In some embodiments, the insulating material may further comprise a colourant. The colourant can be an inorganic colourant. The inorganic colourant may be a ceramic oxide such as ferrous oxide, ferric oxide, magnesium oxide, copper oxide, chromium oxide or manganese oxide. Other suitable inorganic colourants will be known to those in the art.

In some embodiments the insulating material may comprise a fibre or multitude of fibres, such as glass fibres, silica fibres, carbon fibres, carbon nanotubes, alumina fibres, nitride or oxynitride fibres, natural fibres such as coconut fibres, banana tree fibres, hemp fibre, plant fibre or any combination thereof. The addition of fibres may improve the strength and/or fracture resistance of the insulating material. For example, the inclusion of fibres may reduce the tendency of the insulating material to fracture when dropped from a specific height. In some cases, e.g., hemp fibres, the fibres may improve the ability of the insulating material to bounce when dropped for a specific height (e.g., about 2 m).

The fibres may be used in any suitable form, for example, they may be free flowing or they may be in woven sheet form. In some embodiments, the fibres may be in the form of three dimensional (3D) interwoven structures, e.g., mesh or honeycomb structures. For example, the 3D structures may be filled with the insulating material in layers to produce a laminate form.

Suitable dispersants, surfactants, sintering aids, stearate lubricants, ceramic or other additives will be apparent to those skilled in the art. For example, the additives may be high or low molecular weight, organic or inorganic, depending on the intended use. Non-limiting examples of suitable additives may include melamine formaldehyde based dispersants, polyethyleneimine (PEI) dispersants, synthetic lipopeptide surfactants, a surfactant comprising a stearate-based 18-carbon alkyl chains as an anion and a silsesquioxane containing a bridged, positively charged 1,4-diazoniabicyclo[2.2.2]octane group.

In some embodiments, an additive (e.g., a dispersant) may be added during preparation of the insulating material to reduce precipitation and/or agglomeration of one or more of the components (e.g., ceramic oxide, binding agent) when mixed with water. In some embodiments, the use of a dispersant (e.g., a melamine formaldehyde) may improve the homogeneity of the insulating material which may, for example, improve the strength and/or workability of the insulating material. For example, in embodiments in which the insulating material is applied as a spray coating, the use of a dispersant may produce a homogenous material which is easier to spray and provides a more uniform coating.

The insulating material may comprise an additive in any suitable form and/or amount. It will be appreciated by a person skilled in the art that the form and amount of additive will depend on the intended use of the insulating material and the properties to be achieved by use of the additive. In one example, the inorganic binding agent may be mixed with about 0.5 to about 1 wt % of a melamine formaldehyde dispersant and water to form of an aqueous slurry prior to combining with the ceramic oxide.

In a typical method for producing an insulating material according to the present technology, the ceramic oxide and inorganic binding are combined in the presence of water to form a slurry. The ceramic oxide and inorganic binding agent may be added separately or simultaneously. For example, an aqueous slurry of the binding agent may be added to a ceramic oxide powder to provide a mixed slurry, or water may be added to a dry mixture of the ceramic oxide and binding agent. Additional components, such as clay, fly ash or other additives may be included depending on the intended use of the insulating material. The slurry is then formed into a body having the desired shape and dried to produce the insulating material. If necessary, additional water may be provided to reduce the viscosity of the mixed slurry prior to formation of the shaped body. Drying may be carried out in air at room temperature, or it may be carried out under an inert atmosphere such as nitrogen, argon or carbon dioxide. The material may be further treated to moderate (e.g., 60° C.) or high (e.g., up to 1000° C.) temperature, depending on the desired characteristics of the product.

Advantageously, the formation of a slurry allows the viscosity of the material to be controlled prior to formation of the final insulating material. In some embodiments, the amount of water added to form a slurry may be from 10 to about 500 wt % with respect to the total solid content. For example, the amount of water added to form a slurry may be from 10 to about 500 wt %, or about 10 to about 300 wt %, or about 50 to about 500 wt %, or about 100 to about 400 wt %, or about 20 to about 250 wt %, or about 100 to about 300 wt %, e.g. about 10, 20, 50, 100, 150, 200, 250, 300, 350, 400, 450 or 500 wt % with respect to the total solid content. A skilled person will appreciate that the amount of water added during production of the insulating material will depend on the form of material to be produced.

The insulating material may be produced in any shape or form suitable for the intended use. For example, the insulating material may be in the form of a building material, brick, tile, panel, rod, cylinder, block, board, plate, laminate, foam, paint, paste, slurry or dispersion, or combinations thereof. For solid materials, such as a brick, rod or tile, the material may be formed by casting, moulding, extruding, ramming or pressing the material into the desired shape. Liquid or semi-solid forms, such as a slurry, dispersion or foam, may be applied by spraying, brushing or pouring onto a surface or into a cavity, or objects may be dipped in to the liquid to provide a coating. Other suitable methods for forming insulating materials will be known to those skilled in the art.

In some embodiments, pressing may involve applying any suitable pressure to achieve a particular density of the insulating material. For example, pressing may involve applying a pressure of about 1 to about 20 kilonewtons (KN), or about 5 to about 20 KN, or about 5 to about 15 KN, or about 5 to about 10 KN, or about 10 to about 20 KN, or about 10 to about 15 KN. The pressure required to achieve a particular density may depend on the press, mould and/or the way in which pressure is applied.

In some embodiments, the insulating material according to the present technology may provide a coating for various articles or structures. For example, the insulating material may be used as a coating for articles comprising metal, ceramic, glass, timber, polymers, clay, concrete, polystyrene, brick, plaster, Gyprock™, natural or synthetic stone, natural or synthetic fibres, cardboard, laminate, a composite material, or combinations thereof.

The present technology may be particularly useful for the production of laminate structures, in which two dissimilar materials are bonded together. Accordingly, in some embodiments, the insulating material may be used to form a laminate material. For example, the material be used to form a laminate with a woven, mesh or honeycomb material (e.g., metal or polymer based), or a solid panel (e.g., metal, wood or plastic). In some embodiments, the insulating material may be sandwiched between two or more layers of a laminate material to improve the structural strength and/or insulating properties of the laminate structure.

In some embodiments, the insulating material may be used as a coating for a door, wall, container or any solid insulating material according to the present technology. An insulating coating may improve the heat resistance and/or fire rating of an article. Additionally or alternatively, the coating may provide improve the resistance to degradation and/or water resistance compared to the uncoated article. The fire rating of an article may be measured by any suitable method in the art, for example, by ASTM or Australian Standards for fire protection.

Advantageously, the insulating materials of the present technology may be treated or dried at lower temperatures than traditional ceramic materials, which require sintering at high temperatures (e.g., >1200° C.) to impart mechanical strength. This may allow for in situ formation and drying of the insulating material. Other advantages of drying at low temperature may include significant reductions in the time, cost, energy and labour required to produce the material.

In various embodiment, the thermally insulating materials may be treated at temperatures less than that those required to fire brick or ceramic materials. Firing at less than 1000° C. may be sufficient to strengthen the insulating materials while reducing the energy demands required for typical ceramic firing (i.e., >1000° C.). At temperatures above about 1200° C., hollow ceramic oxide microspheres (e.g., cenospheres) soften, thereby reducing the strength of the material. In some embodiments, drying may be achieved at room temperature. In some instances drying may be accelerated by moderate heating, e.g., about 60-80° C. In other embodiments, the insulating materials may be treated by heating to high temperatures. For example, the insulating material may be treated by heating up to about 1000° C. For example, the temperature during production of the insulating materials may be about 1000° C., or about 900° C., or about 800° C., or about 700° C., or about 600° C., or about 500° C., or about 400° C., or about 300° C. or about 200° C., or about 150° C., or about 100° C., or about 50° C., or about 30° C., or about 25° C. or about 20° C.

In various embodiments, drying of the insulating material may occur in situ. For example, in some embodiments the insulating material may be applied as a spray (e.g., a dispersion), or filled onto a cavity in the form of a slurry, or foam. In other embodiments the material may be brushed on to a surface as a paint, paste or slurry to completely or partially coat a structure or object. Drying may then occur at ambient or moderate temperature to produce the desired form of the insulating material without the need for high temperature firing.

Traditional ceramics or clays may exhibit significant dimensional changes during firing. Dimensional changes may include volume, mass, or both volume and mass changes. The present inventor has found that the insulating materials of the present technology may demonstrate relatively good dimensional stability upon heating to high temperatures compared to traditional ceramics, making them suitable for high temperature applications such as fire doors, walls and barriers, and furnaces. In various embodiments, the insulating materials have a mass and/or volume loss of less than about 15% when exposed to heat up to about 1300° C. For example, the mass and/or volume loss may be less than about 15%, or about 14%, or about 13%, or about 12%, or about 11%, or about 10%, or about 9%, or about 8%, or about 7%, or about 6%, or about 5%, or about 4%, or about 3%, or about 2%, or about 1% when heated to 1300° C.

The present inventor has also found that the insulating materials described herein may also show dimensional stability in water. In various embodiments, the insulating materials have a mass and/or volume loss of less than about 15% when stored under water for at least about one year. For example, the mass and/or volume loss may be less than about 15%, or about 14%, or about 13%, or about 12%, or about 11%, or about 10%, or about 9%, or about 8%, or about 7%, or about 6%, or about 5%, or about 4%, or about 3%, or about 2%, or about 1% when stored under water for at least one year. In some embodiments the mass and/or volume loss may be less than about 15% for at least about 1 year, or about 2 years, or about 3 years, or about 4 years, or about 5 years, or about 6 years, or about 7 years, or about 8 years, or about 9 years, or about 10 years. In some embodiments, the insulating materials described herein may demonstrate exceptionally good dimensional stability in water. For example, the mass and/or volume loss may be less than about 1-2% when stored under water for at least about one year, e.g., about 2 years, or about 3 years, or about 4 years, or about 5 years, or about 6 years, or about 7 years, or about 8 years, or about 9 years or about 10 years.

The present inventor has previously developed a process for applying a sol-gel derived nanocoating to an article, published as WO 2002/040398, the entire contents of which are incorporated herein by cross reference. The inventor has found that sol-gel derived ceramic oxide nanocoatings may be applied to the insulating materials of the present technology to, for example, further improve the strength and/or thermally insulating properties of the material. Accordingly, in some embodiments, the insulating material may be further coated with a sol-gel derived ceramic oxide nanocoating.

In some embodiments, the ceramic oxide nanocoating may have an average thickness of less than about 500 nm, e.g., about 500 nm, or about 450 nm, or about 400 nm, or about 350 nm, or about 300 nm, or about 250 nm, or about 200 nm, or about 150 nm, or about 100 nm, or about 50 nm. In some embodiments, the nanocoating may be applied by spraying a dispersion of ceramic sol-gel derived nanocoating solution onto the insulating material according to the procedure described in WO 2002/040398.

The ceramic oxide nanocoating may comprise any suitable ceramic oxide nanoparticles. For example, suitable coatings have previously been described in the inventor, for example, in Choi et al, ‘Advances in Calcium Phosphate Nano-coatings and Nano-composites’ in Besim Ben-Nissan (ed) Advances in Calcium Phosphate Biomaterials, (Springer Heidelberg, 2014), 485-511. In some embodiments, the sol-gel derived ceramic oxide nanocoating may comprise nanoparticles of silica, alumina, partially stabilised zirconia, calcium phosphate, aluminium phosphate or combinations thereof.

In some embodiments, the nanoparticles may have a particles size of less than about 300 nm. In some embodiments, the mean particle size is less than about 300 nm. For example, the particle size may be from about 10 to about 300 nm, or about 10 to about 200 nm, or about 30 to about 300 nm, or about 10 to about 150 nm, or about 50 to about 300 nm, e.g., about 300, 250, 200, 150, 100, 50, or 10 nm.

A typical process for preparing a nanocoating may comprise the steps of:
(a) preparing a solution containing a precursor of the ceramic oxide;
(b) dipping a thermally insulating material according to the present technology, or a portion thereof, into the solution of step (b);
(c) heating the insulating material of step (b) to hydrolyse the ceramic oxide precursor.

Step (c) may comprise heating to a sufficient temperature for a sufficient time to hydrolyse the ceramic oxide precursor, e.g., about 70° C.-130° C. for 24 hours. In some embodiments, step (c) may comprise heating the dipped material to a sufficient temperature for a sufficient time to form crystalline oxides, e.g., from about 500° C. to about 1000° C. for 2 hours. In some embodiments, step (c) may occur simultaneously with drying of the thermally insulating material. It will be understood by a person skilled in the art that the temperature and time will depend, for example, on the particular ceramic oxide precursor, the particle size and/or thickness of the coating.

The strength of an insulating material according to the present technology may be measured by any suitable method known in the art. For example, the compressive strength of the insulating material, which refers to the amount of stress or pressure that can applied to the material under compression before fracturing occurs, may be measured by, for example, three-point and four-point bending tests on solid materials, compression tests, biaxial tests and/or diametral compression tests (“Brazilian test”). Methods for measuring the insulating or thermal properties, such as heat capacity, thermal expansion coefficient, and thermal conductivity of the materials described herein will also be known to those skilled in the art.

The present technology has the advantage of being adaptable to a wide range of applications. Non-limiting examples of applications for the insulating material include:
a. Production of refractory insulating materials for use in construction, such as solid blocks, bricks or panels;
b. Production of solid doors such as fire doors, or coating of doors;
c. Production of structural and non-structural walls and ceilings;
d. Production of lightweight building blocks and bricks;
e. Production of fibre reinforced materials for use, for example, in the building industry as insulating fillers;
f. Filling of walls and ceiling cavities of buildings or structures as a foam to act as sound and heat insulation or barriers;
g. Production of underwater structures;
h. Coating for materials such as plastics, timber or cardboard for producing modular construction materials, e.g., for construction of emergency shelters.
i. Coating of roofing materials (e.g., tiles) for thermal insulation;
j. Fire resistant coating for girders and structural metals;
k. Building foundation filler blocks (e.g., as an alternative to polystyrene blocks);
l. Production of underground structures such as safety bunkers;
m. Construction of containment areas for hazardous materials or fire safety;
n. Construction of storage and safety containers, such as fire resistant air and sea transport containers;
o. Construction of heat containment and heat resistant safety areas in buildings, factories and mines;
p. Construction of furnaces or incinerators;
q. Production of fibre reinforced composite materials, such as laminate or honeycomb structures;
r. Production of heat/fire resistant coatings or covers for electronics, e.g., phones, or 3D printed articles;
s. Production of heat retaining cooking tools, containers, plates and instruments for long term heat retention, e.g., for airline food containers;
t. Heat resistant coatings for cookware and utensils;
u. Production of housings for sensors capable of detecting gases, heat and/or smoke and other responsive devices, such as “smart doors” and “smart constructs”;
v. Production of water resistant, lightweight containers, e.g., for use in gardening or outdoor storage;
w. Production of water resistant, easily assembled, light weight wall panels, e.g., for highways;
x. Production of indoor and outdoor floor tiles; and
y. Coating for a furnace, tundish, crucible, or other container or vessel used, for example, in the mining or casting industries.
z. Use as a coating material to suppress dust in mines and ore transportation.

It will be appreciated by persons skilled in the art that numerous variations and/or modifications may be made to the technology as shown in the specific embodiments without departing from the spirit or scope of the technology as broadly described. The present embodiments are, therefore, to be considered in all respects as illustrative and not restrictive.

### EXAMPLES

### Example 1: Preparation of Sample Compositions

Four sample compositions were prepared as illustrated in Table 1. The ceramic oxides and inorganic binders varied, however typical ceramic oxides included silica, alumina, aluminium silicate and/or partially stabilised zirconia and combinations thereof. Typical binders were calcium orthophosphate, aluminium orthophosphate, sodium silicate and/or calcium silicate and combinations thereof.

Fly ash was obtained from a coal burning power station and was dried at 1000° C. for 2 hours prior to use. The clay used was commercially available ball clay used for ceramic production and was dried at 110° C. for 2 hours.

In a typical procedure, the ceramic oxide(s), fly ash and clay were provided as dry powders. The inorganic binder(s) were provided as a suspension in water and mixed with the dry components at room temperature to form a slurry. Additional water (up to approx. 300 wt % with respect to the solid content of the composition) may be added as required to produce the desired viscosity of the slurry.

TABLE 1
Four representative compositions of a thermally insulating material

| | Composition | Composition | Composition | Composition |
|---|---|---|---|---|
| | A | B | C | D |
| Ceramic | 75 wt % | 18 wt % | 40 wt % | 5 wt % |
| oxide(s) | | | | |
| Inorganic | 25 wt % | 28 wt % | 30 wt % | 30 wt % |
| binder(s) | | | | |
| Fly ash | n/a | 18 wt % | 30 wt % | 50 wt % |
| Clay | n/a | 36 wt % | n/a | 15 wt % |

### Example 2: Preparation of Thermally Insulating Materials

Various thermally insulating materials were prepared using Compositions A-D of Example 1. A summary of the preparation and observations in relation to these materials is provided in Table 2.

### Fibre Reinforced Composite Materials

Slurries prepared from Compositions B and C were deposited by pouring between layers of fibreglass mats (5 or 6 layers) in a mould. Drying was carried out at room temperature to produce the fibre reinforced composite materials as solid plates.

### Coated Wood and Cardboard

Wood and cardboard pieces were partially coated by brushing with, or dipping into, slurries prepared from Compositions A, B and C. Drying was carried out at room temperature to afford a coating with an average thickness of approximately 3 mm.

Thermally insulated cardboard cylinders and laminated cardboard were also prepared using Compositions B and C. Cardboard cylinders were coated by brushing a slurry of Composition B or C onto the outer surface of the cylinders, while laminated cardboard was prepared by dipping the cardboard into a slurry of Compositions B or C. Some coatings additionally comprised glass or hemp fibres, which were added during mixing of the dry ingredients. Drying was carried out at room temperature or 60° C.

### Coated Glass

Thermally insulated glass were prepared by coating glass slides with slurries prepared from Compositions B and C. Coatings were prepared by dipping the glass slides into the slurry or by brushing the slurry on to the glass slides with the same slurry. Glass slides were also coated by power spray coatings prepared from Compositions B and C. Drying was carried out at room temperature or 60° C.

### Solid Bricks

Thermally insulating bricks and tiles were prepared using Compositions B and D. The components were mixed in a cement mixer to prepare a viscous slurry. The mixture was then poured or rammed into a mould and air dried. The air dried compositions were fired to 60° C., 200° C., 500° C. or 1000° C. in a furnace, depending on the intended use. For example, 200° C. is generally sufficient to produce a structural tile, while 500° C. and 1000° C. give good high temperature strength such as required for construction bricks.

A brick was also prepared using a slurry of Composition A pressed at around 5-10 kilonewtons (KN) in a hydraulic metal press. The resultant brick was air dried, then fired in a furnace to 500° C.

### Tiles

Tiles having approximate dimensions of 100×100×10 mm were prepared by pressing a slurry of Composition A, B or D at 5-10 KN pressure in a hydraulic metal press. The tiles were air dried at room temperature, followed by firing to 200° C., 500° C. or 1000° C. for 1 hour.

Tiles prepared from Composition A and fired to 500° C. were further coated with a sol-gel derived zirconia nanocoating according to the procedure described in WO 2002/04039. The nanocoating was dried at 70° C. for 8 hours, followed by slowly heating to 500° C. (holding for 15 minutes) and allowing to cool to room temperature.

### Solid Cylindrical Blocks

Solid cylindrical blocks of approximately 8 mm diameter were prepared using Compositions B, C and D. Each composition was pressed in a hydraulic metal press at a pressure of 5-10 KN. The resultant cylindrical blocks were dried at room temperature, followed by firing at 200° C., 500° C. or 1000° C. for 1 hour.

Solid cylindrical blocks of approximately 18 mm diameter were also prepared using Composition B. The slurry was poured or rammed into a cylindrical mould and allowed to dry at room temperature, treated to 60° C. or fired at 1000° C. for 1 hour.

### Solid Rods and Bars

Insulating rods and bars were produced using Compositions B, C and D (Table 1). Slurries of Compositions B, C and D were extruded to form rods or pressed in a mould to form bars. The rods and bars could be adhered to one another or other similar materials prior to drying without any additional binders. Drying was carried out at room temperature.

### Coated Steel Bars and Sheet Metal

Steel bars and sheet metal were prepared by washing with water, following with acetone or alcohol (ethanol) to remove any grease or oil. The bars were partially coated by brushing or power spray coating with Composition B. The bars were also partially coated with the same compositions comprising 1-5 wt % ferric oxide (Fe₂O₃) as a colourant to achieve various colour intensities. The coatings were allowed to dry at room temperature or 60° C. for 1 hour.

Samples of sheet metal pre-coated with Composition B and dried at 60° C. were further coated with a sol-gel derived silica nanocoating according to the procedure described in WO 2002/04039, with drying at room temperature for 24 hours.

TABLE 2
Preparation of thermally insulating material

| Example | Composition | Production | Drying/firing | Observations |
|---|---|---|---|---|
| Fibre reinforced | B or C | Moulded | Room temp. | Good surface finish and stability. |
| composite | | | | Strength improved with increasing firing |
| | | | | temperature. |
| Partially coated | A, B and C | Dipped or painted | Room temp. or | Excellent coating and good interfacial bonding. |
| wood and | | | 60° C. | Increased stiffness and strength compared to |
| cardboard | | | | uncoated material. |
| Coated cardboard | B and C | Dipped or painted | Room temp. or | Excellent bonding, increased stiffness, good |
| cylinders and | Some coatings | | 60° C. | thermal insulation compared to uncoated material. |
| laminated | additionally | | | Hemp containing coating reduced the tendency for |
| cardboard | comprised glass | | | fracture when dropped from a height of 2 m, and |
| | or hemp fibres | | | increased the tendency to bounce compared to the |
| | | | | hemp-free coating. |
| Coated glass | B and C | Dipped, painted | Room temp. or | Good adhesion. Smooth and homogeneous |
| | | or power spray | 60° C. | covering. |
| | | coated | | |
| Solid bricks | B and D | Poured or | Room temp., then | Good strength, which improved with increased |
| | | rammed into a | fired at 60° C., | firing temperature. |
| | | mould | 200° C., 500° C. or | Smooth, homogeneous structure. |
| | | | 1000° C. | |
| | B and D | Poured or | Room temp., then | Good strength, which improved with increased |
| | | rammed into a | fired at 60° C., | firing temperature. |
| | | mould | 200° C., 500° C. or | Smooth, homogeneous structure. |
| | | | 1000° C. | |
| Tiles | A, B or D | Pressed at 5-10 | Room temp., then | Good surface finish. |
| | | KN | fired at 200° C., | Greater strength with increasing firing temperature. |
| | | | 500° C. or 1000° C. | |
| | A + zirconia | Dipped | 70° C., then 500° C. | Uniform coating on the surfaces and covering of |
| | nanocoating | | | surface porosity, giving improved water resistance. |
| Small solid | B, C and D | Pressed at 5-10 | Room temp., then | Good surface finish. |
| cylindrical blocks | | KN | fired at 200° C., | Greater strength with increasing firing temperature. |
| (8 mm diameter) | | | 500° C. or 1000° C. | |
| Large solid | B | Poured or | Room temp., then | Good surface finish. |
| cylindrical blocks | | rammed into | fired at 60° C. or | Greater strength with increasing firing temperature. |
| (18 mm diameter) | | cylindrical moulds | fired at 1000° C. | |
| Solid rods and | B, C and D | Extruded to form | Room temp. only | Relatively good surface finish. |
| bars | | rods or pressed in | | Greater strength with increasing firing temperature. |
| | | a mould to form | | |
| | | bars | | |
| Coated steel bars | B alone or B | Painted or power | Room temp. or | Good adhesion, smooth colour and homogeneous |
| and sheet metal | comprising 1-5 | spray coated | 60° C. | coating. |
| | wt % ferric oxide | | | |
| | Sheet metal + | Dipped | Room temp. | Smooth coating and can be used for high |
| | B + silica | | | temperature resistance with improved |
| | nanocoating | | | environmental protection. |

### Example 3: Insulating Properties

Two a solid insulating block materials produced according to the process of Example 1. Block BBN1209 was prepared from Composition B and block BBN0109 was prepared from Composition C.

The heat resistance of BBN1209 and BBN0109 were compared to a vermiculate containing industrial insulating block (INS1209) was measured by heating the blocks in a furnace to 1000° C. for 100 minutes. FIG. 2 shows that the temperature of the outer wall of the vermiculate insulator (INS1209) reached 120° C., while the outer wall of BBN1209 and BBN0109 reached about 105° C. and 80° C. respectively.

The temperature of BBN0109 was maintained at 1000° C. for a total of 350 minutes, during which time the external wall temperature did not exceed 80° C.

The results indicate that the insulating materials prepared according to the present technology have greater heat resistance than traditional vermiculite insulating materials, and that heat resistance remains constant over an extended period.

### Example 4: Dimensional Stability

The dimensional stability of solid insulating materials of the present technology prepared according to the procedure of Example 1 (BBN1209) were compared with that of an industrial insulating solid vermiculate material (INS1209) by measuring the % dimensional change (volume) and % mass loss of each material at various temperatures.

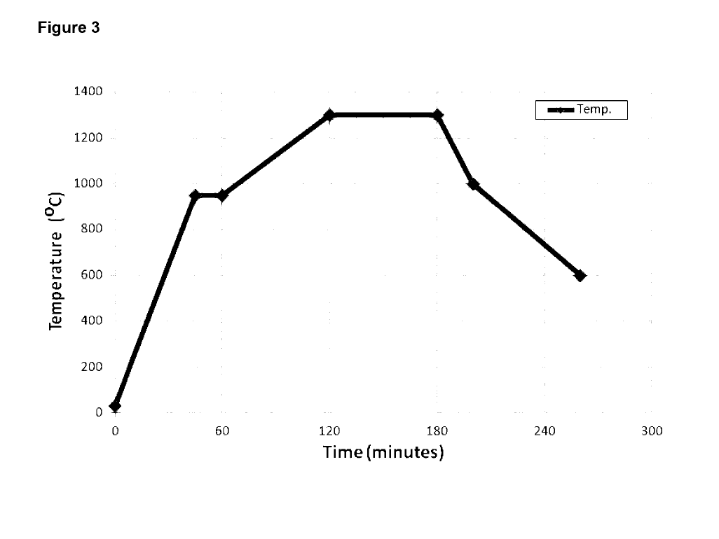

The % dimensional (volume) change and % mass loss was measured after firing in a furnace at 1000° C. for 1 hour, followed by cooling to room temperature. The experiment was repeated at 1100° C., 1200° C. and 1300° C. A typical furnace cycle is illustrated in FIG. 3.

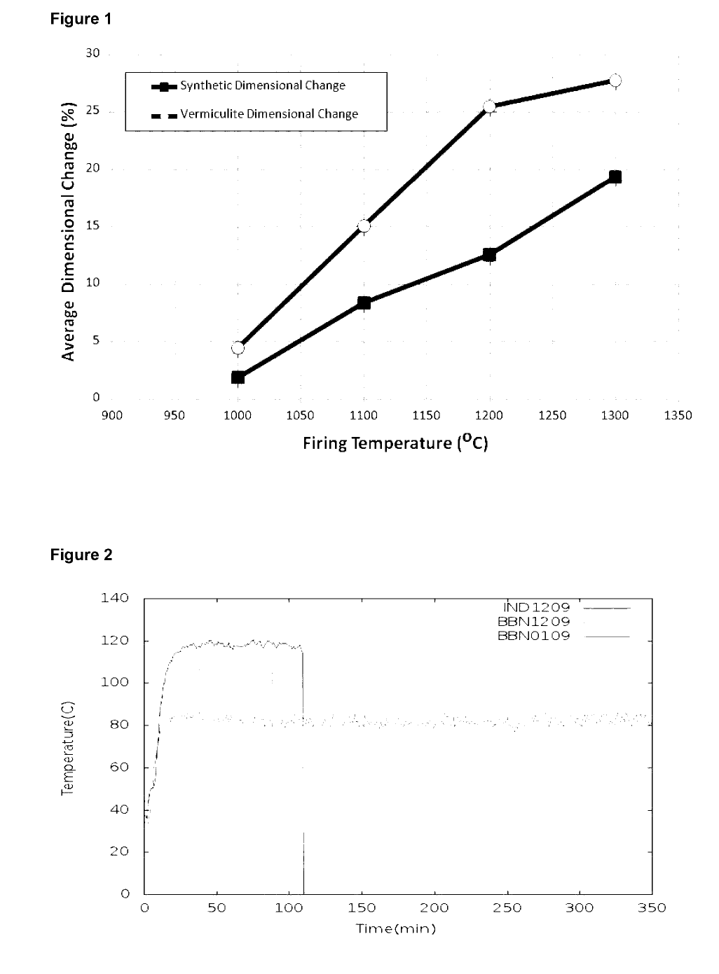

FIG. 1 and Table 3 show the average % dimensional change and % mass loss of 3 replicates after firing at 1000° C., 1100° C., 1200° C. and 1300° C., showing that the insulating brick of the present technology has greater dimensional stability than vermiculite over the temperature range of 1000-1300° C. Table 3 also shows the average % mass loss as a function of temperature for firing at 1100° C. and 1200° C.

TABLE 3
Mass loss (%) and dimensional change (%) of a solid insulating material
of the present technology (BBN 0109) and an industrial insulating solid
vermiculate material at various high temperatures

| | BBN 0109 | | Vermiculite | |
|---|---|---|---|---|
| Firing temp | Mass loss | Dimensional | Mass loss | Dimensional |
| (° C.) | (%) | change (%) | (%) | change (%) |
| 1100 | 7.3 | 8.4 | 9.2 | 15.1 |
| 1200 | 7.2 | 12.6 | 8.6 | 25.5 |

### Example 5: Water Resistance

Extruded rods prepared from Compositions A, B and C under high pressure (5 to 10 KN) and fired at fired at 60° C., 200° C. or 500° C. were stored under water in a glass an unsealed glass vessel. Water levels were replenished as needed so that the rods remained submerged. No visible degradation of the rods was observed after long-term storage.

The strength of the rods was found to be comparable to the strength of similar rods which were not stored under water, suggesting that these materials are also suitable for underwater applications.

It will be appreciated by persons skilled in the art that numerous variations and/or modifications may be made to the invention as shown in the specific embodiments without departing from the spirit or scope of technology as broadly described. The present embodiments are, therefore, to be considered in all respects as illustrative and not restrictive.

1. A thermally insulating material comprising:
(a) 1 to 80 wt % ceramic oxide;
(b) 5 to 30 wt % inorganic binding agent; and
(c) treated at a temperature of less than 1000° C.;
wherein the insulating material does not comprise vermiculite.

2. The insulating material according to claim 1, comprising 5 to 80 wt % ceramic oxide and 10 to 80 wt % ceramic oxide.

3. (canceled)

4. The insulating material according to claim 1, wherein the ceramic oxide has a mean particle size of less than 350 μm or a mean particle size from 30 to 300 μm.

5. (canceled)

6. The insulating material according to claim 1, wherein the ceramic oxide is selected from the group consisting of sodium oxide, magnesium oxide, potassium oxide, calcium oxide, alumina, silica, sodium silicate, magnesium silicate, potassium silicate, calcium silicate, aluminium silicate, zirconium silicate, sodium aluminate, magnesium aluminate, calcium aluminate, zirconium aluminate, nickel aluminate, sodium phosphate, magnesium phosphate, calcium phosphate, aluminium phosphate, ferrous oxide, ferric oxide, zirconium oxide, magnesium zirconate, calcium zirconate, and combinations thereof.

7. The insulating material according to claim 1, comprising 5 to 30 wt % inorganic binding agent.

8. (canceled)

9. The insulating material according to claim 1, wherein the inorganic binding agent has a mean particle size of less than 350 μm or a mean particle size from 30 to 300 μm.

10. (canceled)

11. The insulating material according to claim 1, wherein the inorganic binding agent is selected from the group consisting of calcium orthophosphate, aluminium orthophosphate, sodium silicate, potassium silicate, calcium silicate, and combinations thereof.

12. The insulating material according to claim 1, further comprising 10 to 80 wt % fly ash and 10 to 80 wt % clay.

13. (canceled)

14. The insulating material according to claim 1, further comprising an additive selected from the group consisting of a colourant, fibres, dispersant, surfactant, sintering aid, stearate lubricant, non-oxide ceramic or any combination thereof.

15. (canceled)

16. The insulating material according to claim 1, in the form of a building material, brick, tile, panel, rod, cylinder, block, board, plate, laminate, foam, paint, paste, slurry or dispersion, or combinations thereof.

17. The insulating material according to claim 16, further comprising a ceramic oxide nanocoating.

18. The insulating material according to claim 17, wherein the ceramic oxide nanocoating has an average thickness of less than 500 nm and comprises silica, alumina, aluminum silicate, calcium phosphate, aluminium phosphate, partially stabilised zirconia, or combinations thereof.

19. (canceled)

20. The insulating material according to claim 18, wherein the nanocoating comprises a mean particle size of less than 300 nm.

21. The insulating material according to claim 1, comprising:
(a) 20-80 wt % fly ash;
(b) 10-80 wt % clay;
(c) 1-40 wt % ceramic oxide;
(d) 5-30 wt % inorganic binding agent; and
treated at a temperature of less than 1000° C.

22. The insulating material according to claim 1, comprising:
(a) 75 wt % ceramic oxide;
(b) 25 wt % inorganic binding agent; and
(c) treated at a temperature from 20° C. to 1000° C.

23. The insulating material according to claim 1, comprising:
(a) 18 wt % fly ash;
(b) 36 wt % clay;
(c) 18 wt % ceramic oxide;
(d) 28 wt % inorganic binding agent; and
(e) treated at a temperature from 20° C. to 1000° C.

24. The insulating material according to claim 1, comprising:
(a) 30 wt % clay;
(b) 40 wt % ceramic oxide;
(c) 30 wt % inorganic binding agent; and
(d) treated at a temperature from 20° C. to 1000° C.

25. The insulating material according to claim 1, comprising:
(a) 50 wt % fly ash;
(b) 15 wt % clay;
(c) 5 wt % ceramic oxide;
(d) 30 wt % inorganic binder, and
(e) treated at a temperature from 20° C. to 1000° C.

26. A process for producing a thermally insulating product comprising:
(a) mixing 1 to 80 wt % ceramic oxide, 1 to 30 wt % inorganic binding agent and water to form a slurry;
(b) forming the slurry into a shaped body; and
(c) treating the shaped body at a temperature of less than 1000° C. to produce the thermally insulating product;
wherein the insulating product does not comprise vermiculite.

27-42. (canceled)

43. A method for improving the heat resistance of an article comprising at least partially coating the article with the thermally insulating material according to claim 1.
